(19) United States
(12) Patent Application Publication
(10) Pub. No.: US 2018/0298873 A1
(43) Pub. Date: Oct. 18, 2018

(54) IGNITER

(71) Applicant: IMAGINEERING, Inc., Kobe-shi, Hyogo (JP)

(72) Inventors: Yuji Ikeda, Kobe-shi (JP); Minoru Makita, Kobe-shi (JP)

(73) Assignee: IMAGINEERING, Inc., Kobe-shi, Hyogo (JP)

(21) Appl. No.: 15/768,693

(22) PCT Filed: Oct. 17, 2016
(86) PCT No.: PCT/JP2016/080651

§ 371 Date: Apr. 16, 2018

(30) Foreign Application Priority Data
Oct. 16, 2015 (JP) 2015-204860

(51) Int. Cl. F02P 23/04; F02P 3/01; H01T 13/44; H01T 13/38

(52) U.S. Cl. CPC F02P 23/045; H01T 13/38; H01T 13/44; F02P 3/01

(57) ABSTRACT

An igniter that has a large ignition power and an electromagnetic wave resonance structure with a small reflected power is provided. An igniter comprises a first rectangular substrate and a second rectangular substrate each having a longitudinal side, and at least one intermediate substrate arranged between the first substrate and the second substrate and having a longitudinal side which is shorter than each longitudinal side of the first substrate and the second substrate, the first substrate has an input part configured to receive an input of an electromagnetic wave from an outside, a first electrode, and an electromagnetic wave transmission line that connects the input part to the first electrode, each of the first electrode and the electromagnetic wave transmission line being provided at a surface of the first substrate on a side of the at least one intermediate substrate, the second substrate has an electromagnetic wave resonator and a second electrode that is electrically connected to the electromagnetic wave resonator, each of the electromagnetic wave resonator and a second electrode being provided at a surface of the second substrate on a side of the at least one intermediate substrate, and a space is formed between the first substrate and the second substrate at a position at which the at least one intermediate substrate does not exist therebetween, such that the first electrode and the second electrode are faced each other and located away from each other across the space and a part of the electromagnetic wave transmission line and a part of the resonator are faced each other and located away from each other across the space.

### TECHNICAL FIELD

The present invention relates to an igniter to ignite fuel that is used in an internal combustion engine.

### BACKGROUND ART

Applicant has advanced the development of the art of improving the air/fuel ratio by applying the microwave technique to the combustion in the internal combustion engine (for example, Patent Document 1). In Patent Document 1, it discloses the art that enlarges the ignited flame by irradiating the microwave after igniting fuel by use of the spark plug.

Further, applicant has developed the ignition system that comprises the microwave resonance structure (Patent Document 2). The ignition system of the Patent Document 2 has the structure of boosting the microwave inputted from the outside oscillator by the resonance structure, and causing the discharge between the discharge electrode at the distal end and the ground electrode. If the microwave in pulse state is inputted repeatedly from the outside, the discharge can be caused repeatedly, and the stable ignition can be realized. Moreover, since the plasma (OH radical) can be supplied continuously to the ignition area, the lean combustion can be realized. The diameter is about 4 mm and about ⅓ size of the diameter 12 mm of the normal spark plug, and therefore, the valve diameter can be enlarged, and as a result, it can contribute to the high efficiency of the internal combustion engine. Moreover, since the size has small diameter, it is suitable for the auxiliary igniter for multiple ignition.

### PRIOR ART DOCUMENTS

### Patent Document(s)

Patent Document 1: U.S. Pat. No. 4,876,217

Patent Document 2: WO2015/025913

### SUMMARY OF INVENTION

### Problem to be Solved by Invention

However, since the igniter in the Patent Document 2 has the small diameter, the volume at the discharge area is small. Therefore, if it is used for fuel ignition with the ignition performance inferior to that of the large type internal combustion engine or gasoline such as natural gas, there is a case where the ignition power is insufficient.

Moreover, the matching unit for impedance matching between the outside circuit (for example, 50Ω system) and the resonance structure part are provided inside the plug in the igniter of Patent Document 2. However, if plasma is generated by discharge, an impedance mismatching is caused by the electric resistance change between the discharge electrode and the ground electrode, the microwave is reflected, and the microwave energy cannot be charged to the plasma efficiently. While the measure against the above, for example, microwave input waveform, level control, circuit design that is hard to cause the impedance mismatching, is taken, a basic and fundamental solution is also desirable.

The present invention is made in view of the above problems.

### Means for Solving the Above Problems

An igniter comprises a first rectangular substrate and a second rectangular substrate each having a longitudinal side, and at least one intermediate substrate arranged between the first substrate and the second substrate and having a longitudinal side which is shorter than each longitudinal side of the first substrate and the second substrate, the first substrate has an input part configured to receive an input of an electromagnetic wave from an outside, a first electrode, and an electromagnetic wave transmission line that connects the input part to the first electrode, each of the first electrode and the electromagnetic wave transmission line being provided at a surface of the first substrate on a side of the at least one intermediate substrate, the second substrate has an electromagnetic wave resonator and a second electrode that is electrically connected to the electromagnetic wave resonator, each of the electromagnetic wave resonator and a second electrode being provided at a surface of the second substrate on a side of the at least one intermediate substrate, and a space is formed between the first substrate and the second substrate at a position at which the at least one intermediate substrate does not exist therebetween, such that the first electrode and the second electrode are faced each other and located away from each other across the space and a part of the electromagnetic wave transmission line and a part of the resonator are faced each other and located away from each other across the space.

### Effect of Invention

According to the present invention, ignition stability by an igniter that uses microwave can be improved.

### BRIEF DESCRIPTION OF FIGURES

FIG. 1 is an outside view of a spark plug regarding the first embodiment of the present invention.

FIGS. 2(a)-(c) are views of the spark plug regarding the first embodiment of the present invention, FIG. 2(a) is an exploded and disassembled perspective view in a state of detaching a casing, FIG. 2(b) is a view that shows a back surface side of a first substrate, and FIG. 2(c) is a view that enlarges a distal end part at a front surface side of a second substrate.

FIG. 3 is a cross sectional view of the spark plug regarding the first embodiment of the present invention.

FIG. 4 is a view that shows the front surface of each substrate of the spark plug regarding the first embodiment of the present invention.

FIG. 5 is a view that shows a back surface of each substrate of the spark plug regarding the first embodiment of the present invention.

FIG. 6 is a view that shows an equivalent circuit of the spark plug regarding the first embodiment of the present invention.

FIG. 7 is a view that shows an example of an internal combustion engine that uses the spark plug regarding the first embodiment of the present invention.

FIGS. 8(a)-(c) show another example of the internal combustion engine that uses the spark plug regarding the first embodiment of the present invention, FIG. 8(a) is a partially cross-sectional view before piston rise up, FIG. 8(b) is the partially cross-sectional view after piston rise up, i.e., near TDC, and FIG. 8(c) is the view that the piston at that time is seen from the top surface.

FIG. 9 is a view of the internal combustion engine that performs multiple ignitions regarding reference example.

FIG. 10 is a schematic view that shows a second embodiment of the present invention.

FIGS. 11(a)-(d) show an ignition plug regarding the second embodiment of the present invention, FIG. 11(a) is an overall plan view, FIG. 11(b) is an A-A cross sectional view of FIG. 11(a), FIG. 11(c) is a front view seen from the discharger side, and FIG. 11(d) is a perspective view of showing a resonance electrode.

### EMBODIMENTS FOR IMPLEMENTING THE INVENTION

In below, embodiments of the present invention are described in details based on figures. Note that, following embodiments are essentially preferable examples, and the scope of the present invention, the application, or the use is not intended to be limited.

### First Embodiment

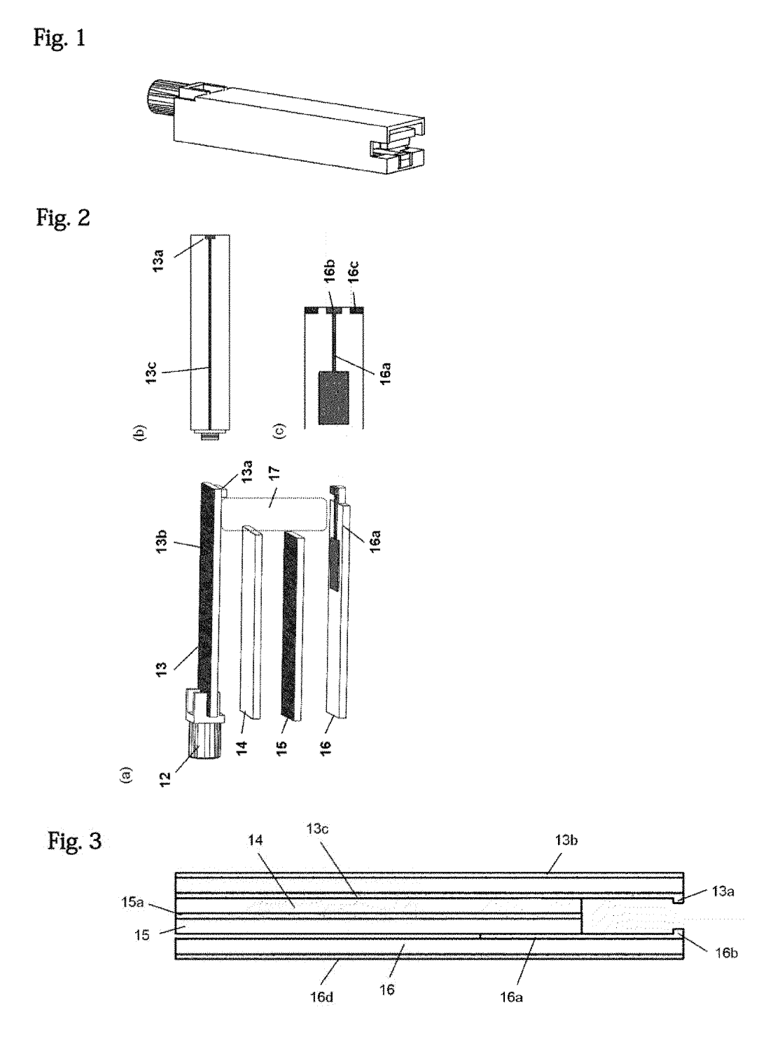

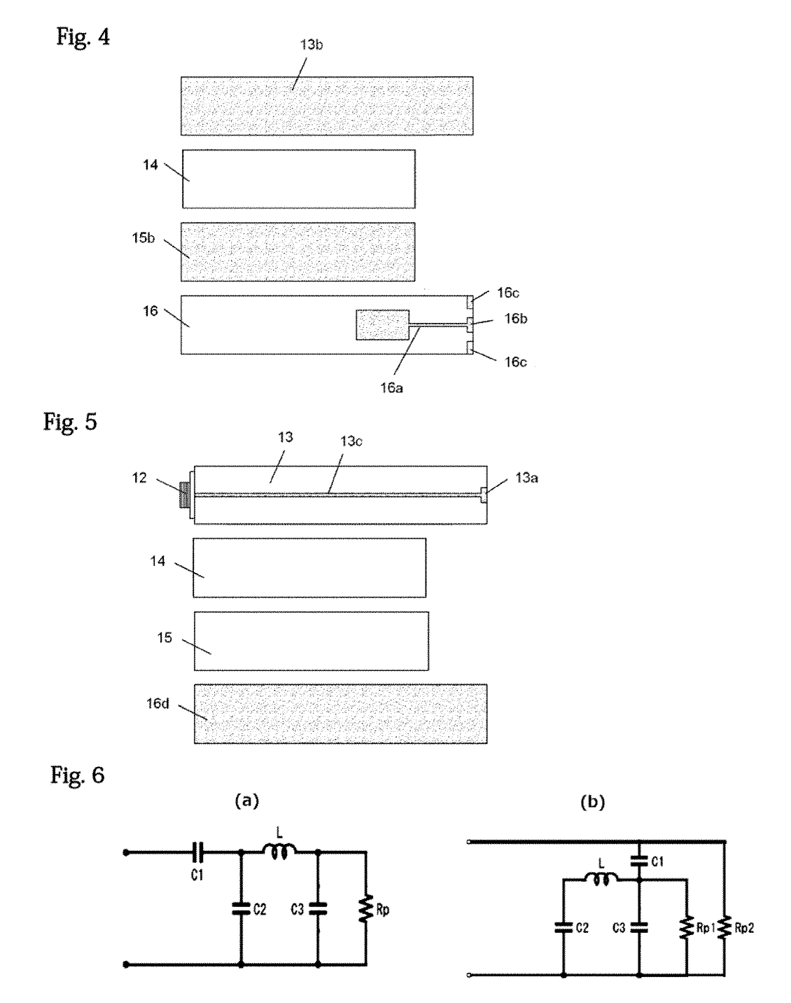

Seen FIG. 1 through FIG. 5, a spark plug 1 of the present embodiment, comprises, seen from up to down in order, a first substrate 13, an intermediate substrate 14, an intermediate substrate 15, and, a second substrate 16, and these four substrates are stored inside a rectangular casing 11. Furthermore, each of all the four substrates is constituted of an insulating material such as ceramics.

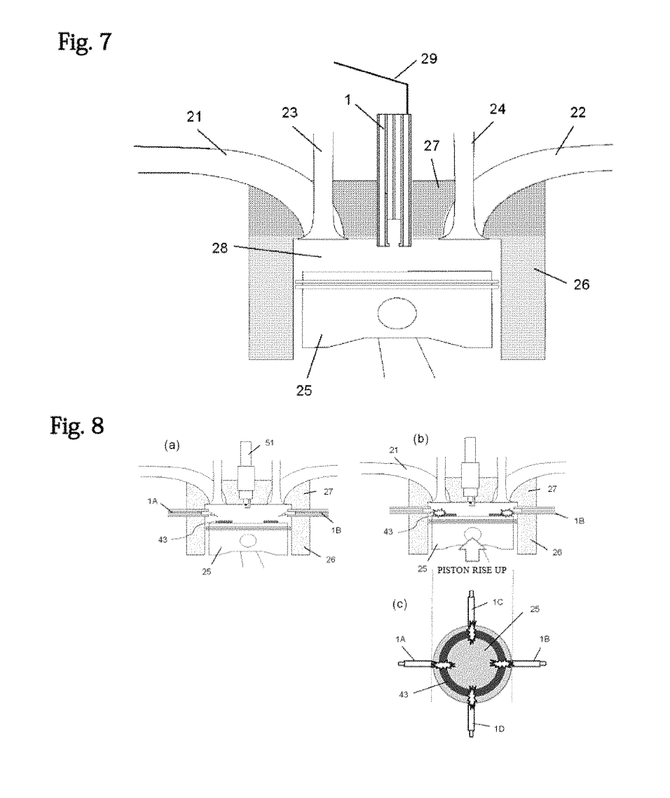

SMA connecter 12, to which a coaxial cable 29 (referring to FIG. 7 and etc.) that transmits microwave generated at the outside oscillator (not-illustrated) is connected, is mounted at a shorter left side of the first substrate 13. A metal pattern 13b that prevents the microwave from leaking to the outside is formed fully across the surface on the top surface of the first substrate 13. Moreover, an electrode 13a is formed at the bottom surface side of the first substrate 13 and at the right end of the shorter side, and a microwave transmission line 13c having a metal pattern in a strip line manner is formed so as to connect the electrode 13a to SMA connecter 12 electrically.

A resonator 16a is formed at the top surface of the second substrate 16, and a discharge electrode 16b is formed so as to be electrically connected to the resonator 16a at the right shorter side, while a ground electrode 16c is formed closely to the discharge electrode 16b although being separated in a space therebetween. Further, a metal pattern 16d which prevents the microwave flowing through the resonator 16a from leaking to the outside is formed fully across the surface on the bottom surface of the second substrate.

An intermediate substrate 14 and 15 are placed so as to be sandwiched between the first substrate 13 and the second substrate 16, and the intermediate substrates 14 and 15 having a longitudinal side which is shorter than each longitudinal side of the first substrate 13 and the second substrate 16. Therefore, the right side at the bottom surface of the first substrate 13 and the right side at the top surface of the second substrate 16 are opposed from each other with being separated in space therebetween. That is, a space is formed between the first substrate 13 and the second substrate 16 at a position at which the at least one intermediate substrate 14 does not exist therebetween, such that the first electrode 13a and the discharge electrode 16b are faced each other and located away from each other across the space and a part of the electromagnetic wave transmission line 13c and a part of the resonator 16a are faced each other and located away from each other across the space. This space functions as a coupling part 17 so as to lead the microwave flowing through the microwave transmission line 13c of the first substrate 13 to the resonator 16 of the second substrate 14 by an electric field coupling. Moreover, a metal pattern that shields the microwave flowing through the microwave transmission line 13c of the first substrate 13 against the second substrate 16, is formed on the top surface of the intermediate substrate 15. Note that, the metal pattern may be formed on the bottom surface of the intermediate substrate 14.

Next, the spark plug operation is illustrated. The microwave inputted from SMA connecter 12 transmits through the microwave transmission line 13c. Then, the microwave is induced to the resonator 16 of the second substrate 16 by the electric field coupling through the above coupling part 17. The resonator 16 has a microwave resonance structure, and the microwave induced to the resonator 16 is amplified and becomes high in potential at the discharge electrode 16b. As a result, discharge occurs between the discharge electrode 16b and the ground electrode 16c (In below, the discharge is called as a “first discharge”). The plasma is generated by the first discharge, this being a fire seed, and then, the discharge occurs to and/or from the electrode 13a of the first substrate 13 (In below, the discharge is called as a “second discharge”).

Note that, a distance between the discharge electrode 16b and the ground electrode 16c is 0.3 mm, for example. Moreover, a distance between the discharge electrode 16b and the electrode 13a is 4 mm, for example. Accordingly, the discharge volume of the second discharge is larger than that of the first discharge. Note that, since the length of the discharge gap of the spark plug having the conventional microwave resonance structure as Patent Document 2 is 0.3 mm, the discharge volume of the spark plug of the present invention is larger than that of the conventional one, and larger size of plasma can be generated.

A reflection occurs when the plasma is generated by discharge in the spark plug of the conventional microwave resonance structure. This is explained by using an equivalent circuit. FIG. 6(a) illustrates an equivalent circuit of the resonance structural part of the spark plug having the conventional microwave resonance structure. When the microwave is inputted from the outside microwave oscillator firstly, the current flows from left to right side of FIG. 6(a) towards the capacitor C1. Next, resonating with the microwave frequency, when the strong resonance current flows to the loop circuit that comprises the reactance L, the capacitors C3 and C2, a high voltage is generated at both the ends of the capacitor C3 especially and the breakdown occurs at both the ends of the capacitor C3 so as to discharge, and the plasma is generated. The state of both the ends of the capacitor C3 is equivalent to a state of the resistance “Rp” in a manner of being connected in parallel changed from the release state. Thereby, the state that the impedance matches to the outside circuit originally 50Ω system is changed into an impedance mismatched state, and therefore, the microwave is reflected.

On the other hand, FIG. 6(b) is an equivalent circuit of the resonance structural part of the spark plug 1 regarding the first embodiment of the present invention. In a state where plasma is not generated, both the ends of the resistance Rp1 and Rp2 is considered to be equivalent to the released state. When the microwave is inputted from the outside microwave oscillator, firstly the current flows into the capacitor C1. Resonating with the microwave frequency, when the strong resonance current flows into the loop circuit that comprises the reactance L, the capacitors C3 and C2, a high voltage is generated at both ends of the capacitor C3 especially. The breakdown occurs at both the ends of the capacitor C3 so as to discharge, and plasma is generated (This corresponds to the above “first discharge”). The state of both the ends of the capacitor C3 changes from the released state to the resistance “Rp” connection in parallel state. In this state, since the impedance mismatched state occurs as well as the conventional spark plug (a), the amount of the reflected wave is increased. Next, the plasma generated at both the ends of the capacitor C3 is made to a fire seed, and then, the discharge occurs to and/or from the transmission line (the microwave transmission line 13c) (This corresponds to the above “second discharge”). Thereby, the strong current flows between the transmission line and the ground (GND) (Seen from the electrical circuit viewpoint, the state changes from the released state to the resistance “Rp2” connection state.) However, since the resonator 16 is not mediated in a case of discharge at the path directly-connected to the transmission line, the amount of the reflection generation caused by the impedance mismatch can be reduced, and the input power can be provided to the plasma with high efficiency. That is, the time period of the reflected wave increase can be suppressed to only within the time period of the above first discharge, and the amount of the reflected wave can be suppressed to become small at the time period of the second discharge.

Note that, for example, the reflectance caused by plasma generation is about 80% at the spark plug having the conventional type microwave resonance structure; however, it is ascertained experimentally that the reflectance can be kept under about 10% at the spark plug 1 regarding the first embodiment of the present invention.

Secondly, an example of using the spark plug of the present invention is illustrated. FIG. 7 illustrates a view that shows an example of using the spark plug 1 in place of the spark plug.

FIG. 8 is an example showing that the spark plug 1 is provided at the lateral side of the combustion chamber. Referring to (a) through (c) of the same Fig, four spark plugs 1A through 1D are inserted between the cylinder block 26 and the cylinder head 27 (at the point at which the gasket is inserted generally). On the other hand, an annular type receiving antenna 43 is formed at the top surface of the piston 25. The microwave is supplied to the spark plug 1 at the timing when the piston 25 reaches to the TDC (top dead center) so as to cause the above “second discharge”. Accordingly, the second discharge is expanded to the receiving antenna 43, and the large size of discharge can be caused between the spark plug 1 and the receiving antenna 43. Thereby, knocking and etc. can be suppressed.

At above, the embodiment of the present invention was explained. The scope of the present invention should be defined based on the claims absolutely, and it should not be limited to the above-mentioned embodiment.

The microwave is explained as one example of an electromagnetic wave in the above example; however, an electromagnetic wave at other waveband may be used.

Moreover, a reciprocating gasoline engine for vehicle or a rotary gasoline engine is supposed as the internal combustion engine in which the present igniter is applied; however, the present igniter may be applied to an engine being fueled by natural gas or an engine being fueled by diesel oil for example.

The first discharge becomes generated between the discharge electrode 16b and the ground electrode 16c as above; however, a metal part of a casing 11 functions as the ground electrode for example, and the discharge may be generated between the discharge electrode 16b and the casing 11.

### REFERENCE EXAMPLE

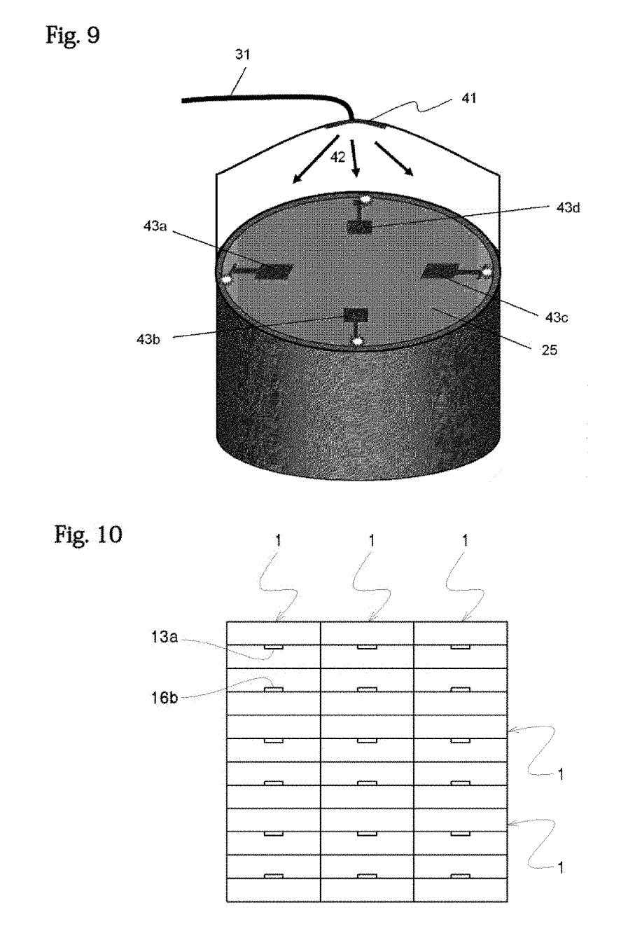

FIG. 9 illustrates an igniter for multiple ignitions regarding the reference example. The microwave transmitted by the coaxial cable 29 is emitted from a flat antenna 41 provided at the cylinder head towards the combustion chamber 42, and the microwave is received by the receiving antennas 43a through 43d provided at the top surface of the piston 25. Each receiving antenna 43 comprises a flat type patch antenna with 8 through 9 millimeter square and a resonator, and the receiving antenna 43 has the structure that the microwave received at the patch antenna part is amplified at the resonator so as to discharge at a distal end of the resonator. Thereby, the multiple ignitions can be realized.

### Second Embodiment

A spark plug of the second embodiment, as illustrated in FIG. 10, is formed by firstly laminating each substrate 13 through 16 so as to constitute the spark plug and secondly bundled together so as to form the multiple spark plugs. In the figure example, it shows an example that three rows in a matrix in a plain, i.e., total nine substrates, are bundled together; however, for example, four rows in a matrix in a plain, i.e., total sixteen substrates bundling together can be made, and not limited into this.

As explained as above, one of shorter sides of the first substrates 13 of multiple ignition plugs 1 becomes an input part of the electromagnetic wave. It is structured that a connecter, for example, SMA connecter 12 that is connected to the coaxial cable 31 contacting to the electromagnetic wave oscillator, is provided at each input part, and each input part may be constituted to contact to the outside electromagnetic wave oscillator; however, each input part may be connected via a distributer. Moreover, each input part (the reverse side distal part of the electrode 13a of the transmission line 13c) is electrically connected, contacted to one outside electromagnetic wave oscillator, and an electromagnetic wave (microwave) may be transmitted to each spark plug 1 without mediating the distributer.

### Third Embodiment

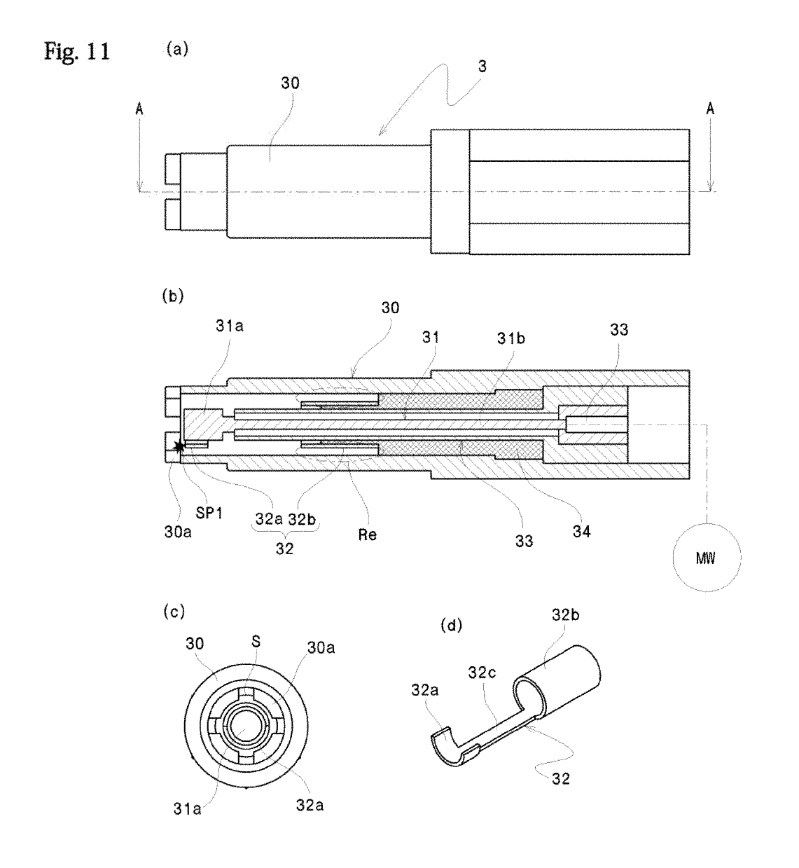

A spark plug of the third embodiment is the spark plug that the equivalent circuit (referring to FIG. 6(b)) of the substrate type spark plug 1 illustrated in the first embodiment is realized in a cylindrical type. The spark plug 3 comprises, as illustrated in FIG. 11, a hollow cylindrical type casing 30, a center electrode 31 that is substantially coaxial to the hollow cylindrical type casing 30, one end of which is contacted to an input part 33 being connected to an outside electromagnetic wave oscillator MW, the other end of which is contacted to an antenna part 31a for emitting an electromagnetic wave being supplied from the input part 33, a shield pipe 33 that surrounds an axial part 31b having a smaller diameter than the antenna part 31 that functions as connection of the input part 33 to the antenna part 31a of the center electrode 31, and a resonance electrode 32 having a discharger 32a that surrounds the antenna part 31a and a cylindrical resonator 32b that surrounds the shield pipe 33. Then, an electromagnetic wave supplied at a resonance part “Re” is amplified, the difference in potential between the discharger 32a and a ground electrode 30a formed at the distal end of the casing 30 becomes large, and a first plasma “SP1” is generated.

The discharger 32a configured to surround the antenna part 31a that constitutes the resonance electrode 32, may be a cylindrical part; however, as illustrated in FIG. 11(d), it is constituted in a semi-circle type. A connector 32c that remains an arc part in about from 15 degree to 30 degree and the other part are cut and notched, connects the discharger 32a to the resonator 32b. As clearly illustrated in the figure, the resonance electrode 32 is manufactured by being notched of thin cylindrical metal material. The ground electrode 30a formed at the distal end of the casing 30, as shown in FIGS. 11(b) through (c), may preferably form multiple notch portions (slit S), thereby, an ignition performance to fuel mixture on mounting to the internal combustion engine can be enhanced.

The shield pipe 33 functions as a shield not for being capacity-coupling of an electromagnetic wave that is supplied from the axial part 31b to the resonator 32b, and the shield pipe 33 is electrically insulated from the center electrode 31 and the resonance electrode 32. One end of the shield pipe 33 is formed integrally together with the input part 33, and the shield pipe 33 is configured to be secured on the ground-electrode-opposite-side inside the casing 30. An insulating material such as ceramic pipe or ceramic powder may be filled with between an inner circumferential surface of the shield pipe 33 and an outer circumferential surface of the center electrode 31 so as to insulate. Moreover, an insulating pipe is preferably provided between an outer circumferential surface of the shield pipe 33 and an inner circumferential surface of the resonator 32b, and an insulating pipe 34 that matches in shape along a step difference of an inner circumferential surface of the casing 30 and a clearance shape of the outer circumferential surface of the shield pipe 33 and the inner circumferential surface of the resonator 32b is preferably arranged so as to perform a positioning of the resonance electrode 32.

In the above structure, an electromagnetic wave supplied from the outside electromagnetic wave oscillator MW (a microwave having 2.45 GHz in the present embodiment) mediates the discharger 32a after transmitted from the antenna part 31a of the center electrode 31, then, amplified at the resonance part “Re” formed between the outer circumferential surface of the resonator 32b of the resonance electrode 32 and the inner circumferential surface of the casing 30, and the potential in difference is increased between the discharger 32a of the resonance electrode 32 and the ground electrode 30a. As a result, the first plasma SP1 is generated between the discharger 32a and the ground electrode 30a. The antenna part 31a and the discharger 32a form the capacitor being capacity-coupled.

The impedance mismatch occurs by generating the first plasma SP1; however, the electromagnetic wave passing through the center electrode 31 that does not mediate the resonance part “Re”, is supplied from the antenna part 31a to the first plasma SP1, and the first plasma SP1 is maintained and expanded.

In a case where the spark plug 3 is used to the internal combustion engine, the supplied electromagnetic wave is in a pulse manner at an oscillation time period from 5 micro seconds to 20 micro seconds so as to generate the first plasma SP1 at substantially similar timing to the general spark plug ignition timing, and thereafter, it is preferable that the electromagnetic wave oscillates at the oscillation time period from 10 nanoseconds to 500 nanoseconds as shorter timing as possible. In the present embodiment, the electromagnetic wave oscillates at 50 nanoseconds, and the duty ratio is 50 percent (the duty ratio is from 30 percent to 80 percent, preferably from 40 percent to 60 percent). Then, the number of oscillation is from 300 to 1000 times, preferably from 600 to 800 times, and, in the present embodiment, about 700 times oscillation of the electromagnetic wave.

Such an oscillation pattern is performed in the above cylindrical type spark plug that can be illustrated by the equivalent circuit shown in FIG. 6(b), thereby, the first plasma SP1 is maintained, expanded, and a reliable combustion in so called as “super lean state” with high air/fuel ratio can be maintained by the plasma generated only by the electromagnetic wave.

### NUMERAL SYMBOLS EXPLANATION

1. Spark Plug
12. SMA Connecter
13. First Substrate
13a. Electrode
13c. Microwave Transmission Line
14. Intermediate Substrate
15. Intermediate Substrate
16. Second Substrate
16a. Resonator
16b. Center Electrode
16c. Ground Electrode
3 Igniter (Spark Plug)
30 Casing
31 Center Electrode
31a Antenna
31b Axial Part
32 Resonance Electrode
32a Discharger
32b Resonator
32c Connecter
33 Shield Pipe

1. An igniter comprising:
a first rectangular substrate and a second rectangular substrate each having a longitudinal side; and
at least one intermediate substrate arranged between the first substrate and the second substrate and having a longitudinal side which is shorter than each longitudinal side of the first substrate and the second substrate, wherein
the first substrate has an input part configured to receive an input of an electromagnetic wave from an outside, a first electrode, and an electromagnetic wave transmission line that connects the input part to the first electrode, each of the first electrode and the electromagnetic wave transmission line being provided at a surface of the first substrate on a side of the at least one intermediate substrate,
the second substrate has an electromagnetic wave resonator and a second electrode that is electrically connected to the electromagnetic wave resonator, each of the electromagnetic wave resonator and a second electrode being provided at a surface of the second substrate on a side of the at least one intermediate substrate, and
a space is formed between the first substrate and the second substrate at a position at which the at least one intermediate substrate does not exist therebetween, such that the first electrode and the second electrode are faced each other and located away from each other across the space and a part of the electromagnetic wave transmission line and a part of the resonator are faced each other and located away from each other across the space.

2. An igniter according to claim 1, wherein the input part is arranged at one of shorter sides of the first substrate, and the first electrode is arranged at the other of the shorter sides of the first substrate.

3. An igniter according to claim 1, which is configured such that an electromagnetic wave that flows through the electromagnetic wave transmission line is induced to the resonator by an electric field coupling, the induced electromagnetic wave is amplified by the resonator, thereby causing a first discharge at the second electrode, so as to trigger a second discharge with, a discharge volume larger than the first discharge between the second electrode and the first electrode, thereby performing an ignition.

4. An igniter according to claim 1, further comprising:
a ground electrode arranged in a vicinity of the second electrode on the second substrate such that the first discharge is caused between the second electrode and the ground electrode.

5. An igniter comprising:
a cylindrical casing having a hollow extending substantially in an axis direction;
a center electrode coaxially provided with the cylindrical casing, the center electrode having
at one end of the center electrode, an input part connected to an external electromagnetic wave oscillator,
at another end of the center electrode, an antenna part configured to emit an electromagnetic wave supplied from the input part, and
an axial part that connects the antenna part to the input part;
a shield pipe that surrounds the axial part of the center electrode; and
a resonance electrode comprising a discharger that surrounds the antenna part and a cylindrical resonator that surrounds the shield pipe.
